(19) United States
(12) Patent Application Publication
(10) Pub. No.: US 2014/0061269 A1
(43) Pub. Date: Mar. 6, 2014

(54) Easy to attach rear passenger backrest, arm rests and luggage rack device for a motorcycle

(71) Applicants: Jerry Hawkins, Sullivan, IN (US); Jerry Abram, Sullivan, IN (US)

(72) Inventors: Jerry Hawkins, Sullivan, IN (US); Jerry Abram, Sullivan, IN (US)

(21) Appl. No.: 14/016,072

(22) Filed: Aug. 31, 2013

Related U.S. Application Data
(60) Provisional application No. 61/696,167, filed on Sep. 1, 2012.

(51) Int. Cl. B62J 7/04; B62J 1/00

(52) U.S. Cl. CPC B62J 7/04; B62J 1/007
USPC 224/413

(57) ABSTRACT

A device for touring motorcycles including a passenger backrest, a pair of pivoting arm rests and rear luggage rack device used as a modification kit that enables riders to add an assembly to function as a luggage rack, a passenger seat and an arm rest whereby device is a unit that: is comfortable, is durable, affords additional luggage capabilities, is lightweight, is attractive, and offers a relative to ground level lower center of gravity for the luggage as compared to a standard touring box.

### CROSS-REFERENCE TO RELATED APPLICATIONS

This application claims the benefit of Provisional Patent Application Ser. No. 61/696,167 filed Sep. 1, 2012 by Jerry Hawkins and Jerry Abram entitled “An easy to attach rear passenger backrest, arm rests and luggage rack device (for a motorcycle) called a STRONGRAK”.

### FIELD OF INVENTION

This invention relates to an easy to attach rear passenger backrest, arm rests and luggage rack device (for a motorcycle) called a STRONGRAK. Particularly this motorcycle accessory is related to a touring motorcycle modification kit that enables riders to add an assembly configurable to function as a luggage rack and as a backrest for a passenger seat and arm rest combination.

The easy to attach device has a simple means to attach the STRONGRAK securely and quickly to the motorcycle. It also is configured to not harm or scratch any surfaces and may be removed to return the motorcycle back to its original condition. The device anticipates aftermarket installations but is conceivably adapted to original equipment sales as well.

### FEDERALLY SPONSORED RESEARCH

None.

### SEQUENCE LISTING OR PROGRAM

None.

### BACKGROUND

### Field of Invention and Prior Art

Problem Addressed and Solved:

Motorcycles include a front wheel and a rear wheel that rotate about separate axles to allow the motorcycle to travel along a road or path. The rider sits on a seat disposed behind the front wheel and substantially in front of and/or above the rear wheel. Some motorcycles may include an elongated seat that allows not only the rider to ride on the motorcycle but also allows another passenger to accompany the rider. Here the additional passenger sits on the same seat as the rider but is positioned behind the rider. In addition to carrying additional passengers, it is also sometimes desirable to carry luggage on a motorcycle. Some motorcycles allow for the carrying of luggage on the seat behind the rider. However, with luggage in this position, there is no space for an additional passenger. It is desirable and needed to have a comfortable back rest, arm rest for the passenger as well as a luggage area. The current easy to attach rear passenger backrest, arm rests and luggage rack device (for a motorcycle) called a STRONGRAK addresses and solves this need.

Prior Art:

Many persons have attempted to solve the above stated problem in the motorcycle industry. However, as far as known, there are no other “easy to attach” rear passenger backrest, arm rests and luggage rack devices (for a motorcycle) or the like. It is believed that this product is unique in its design and technologies.

U.S. Patent Application Publication 2008/0174099 by Brown shows a touring kit with a very high center of gravity and a complex assembly method. This is fax more complex than the Hawkins innovation. Another device by Stamatakis is U.S. Pat. No. 5,553,915 issued in 1996. Here is a device with an “ad-on” seat, but fixed arms and no luggage carrier.

In 1996, Reichert showed the industry a U.S. Pat. No. 5,558,260 entitled “Detachable motorcycle passenger seat and/or luggage rack”. It was more complex and provide either a seat or a rack—not both at the same time as what Hawkins provides. A device by Zagrodnik in 1996, U.S. Pat. No. 5,725,138, shows a seat, no arm rests, and small rack. The device is not readily detachable like Hawkins.

Reichert again shows a U.S. Pat. No. 5,931,360 in 1999. Again it is a seat or rack, not both and the seat has no provisions for arm rests. Another device is shown by U.S. Patent Application Publication 2002/0011745 by Peterson. Here an adjustable back rest and cargo carrier is awkwardly added and affixed—essentially permanently—to a motorcycle. It has no arm rests nor any simple removal provisions. In 2007, Colbert et al in U.S. Design Pat. D555,047 show a motorcycle arm rest assembly, but not the back rest or luggage rack as part of the design. Again restated, as far as known there are no other “easy to attach” rear passenger backrest, arm rests and luggage rack devices (for a motorcycle) or the like. It is believed that this product is unique in its design and technologies.

### SUMMARY OF THE INVENTION

This invention is an easy to attach rear passenger backrest, arm rests and luggage rack device (for a motorcycle) called a STRONGRAK. Taught here are the ways a removable accessory combination for a motorcycle may be safely and securely adapted to a motorcycle for use of a passenger and for luggage. This may be as an aftermarket product or an add-on option as original equipment.

The preferred embodiment of the easy to attach rear passenger backrest, arm rests and luggage rack device (for a motorcycle) called a STRONGRAK is comprised of a (a) a backrest assembly; (b) a pair of arm rest members consisting of a left and right structure; (c) a means for pivotally securing each of the arm rest structures to the backrest assembly; (d) an essentially flat or planar luggage rack with a front and rear end and two sides and with an upper and lower surface; (e) a means for connecting the backrest assembly securely to the front end of the luggage rack; and (f) a means for removably securing the lower surface of the luggage rack to a slot in a support of the motorcycle wherein the Strongrak may be removably secured on the motorcycle support for use by a motorcycle passenger. The device may be of various coated or plated metals, composite materials and other durable materials as one skilled in the art of motorcycle accessories well appreciates.

The newly invented Special backrest, armrest and luggage rack device may be manufactured at low volumes by very simple means and in high volume production by more complex and controlled systems.

### Objects and Advantages

There are several objects and advantages of the Strongrak combination device. There are currently no known motorcycle accessories that are effective at providing the objects of this invention.

Long distance touring on a motorcycle has always been a comfort challenge. Therefor it is the intent of the inventors to manufacture a unit that is:

| Item | Advantages |
|---|---|
| A | Comfortable |
| B | Durable |
| C | Affords additional luggage capabilities |
| D | Lightweight |
| E | Attractive |
| F | Offers lower center of gravity for luggage |

A. Comfort The above unit has been designed to offer the passenger on a motorcycle the needed comfort for long distance travel, by having arm rests to help support the body due to the wind and natural movements that are ever present on a motorcycle. The backrest incline angle was engineered for passenger comfort and adequate separation from the front rider.
B. Durability This unit is manufactured with few moving parts, and high quality materials, to withstand the vibrations and rigors created by the motorcycle.
C. Luggage capabilities The luggage rack is of rugged design, necessary for attaching luggage while traveling for long distances and extended time.
D. Lightweight The construction of this unit was done using lightweight material, while not sacrificing strength. The lightweight design offers the above mentioned assembly better luggage carrying potential than normal “tour box-backrest” with less weight.
E. Attractive appearance This is a motorcycle accessory that does not detract from the beauty of a motorcycle while making the rider and passenger comfortable.
F. Lower center of Gravity Keeping the center of gravity as low as possible makes the motorcycle handle better and the riding safer. This unit allows luggage to be added at a lower place than the top rack on a normal touring motorcycle tour box.

Finally, other advantages and additional features of the present Strongrak combination device will be more apparent from the accompanying drawings and from the full description of the device. For one skilled in the art of motorcycle accessories and the like, it is readily understood that the features shown in the examples with this product are readily adapted to other types of motorcycle accessories and devices.

### DESCRIPTION OF THE DRAWINGS

### Figures

The accompanying drawings, which are incorporated in and constitute a part of this specification, illustrate an embodiment of the easy attach rear passenger backrest, arm rests and luggage rack device (for a motorcycle) called a STRONGRAK that is preferred. The drawings together with the summary description given above and a detailed description given below serve to explain the principles of the Special backrest, armrest and luggage rack device. However, it is understood that the Special backrest, armrest and luggage rack device is not limited to only the precise arrangements and instrumentalities shown.

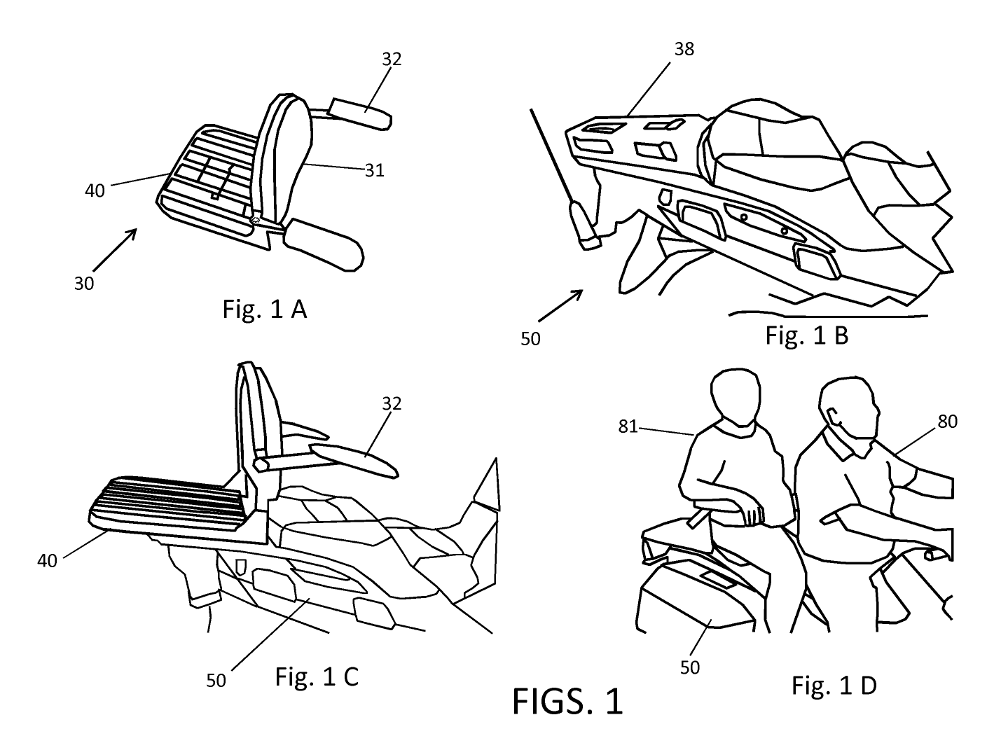

FIGS. 1 A through 1 D are sketches of the general passenger backrest, arm rests and luggage rack device (for a motorcycle) called a STRONGRAK.

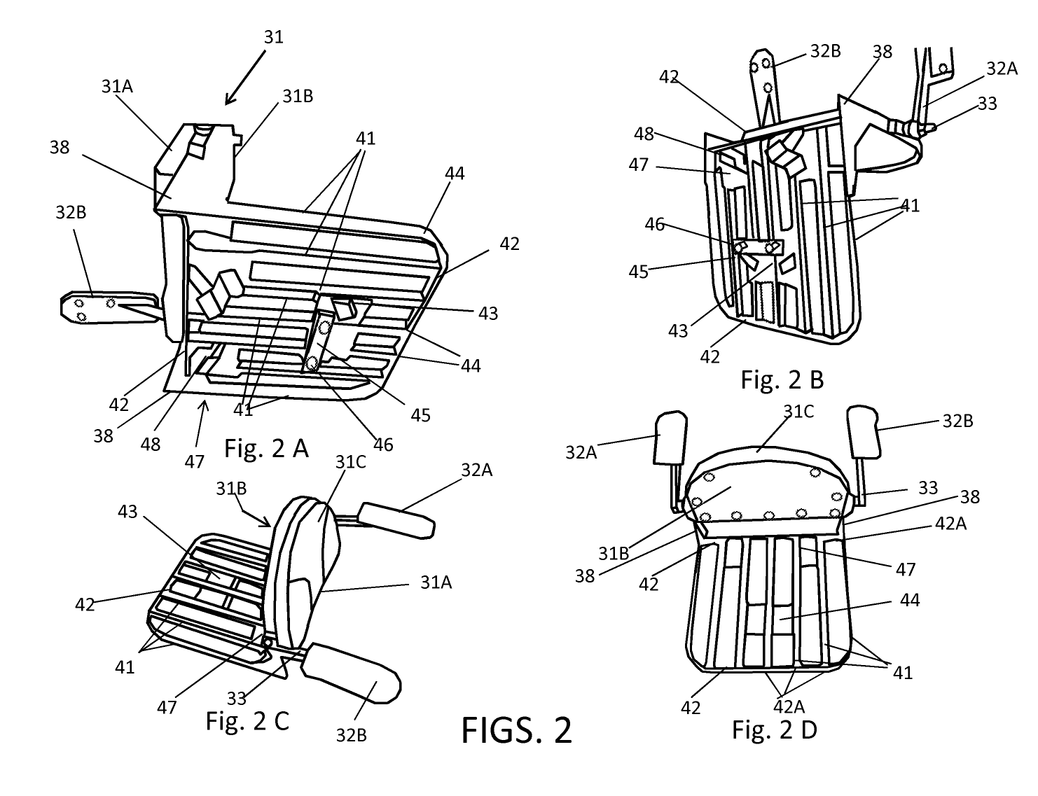

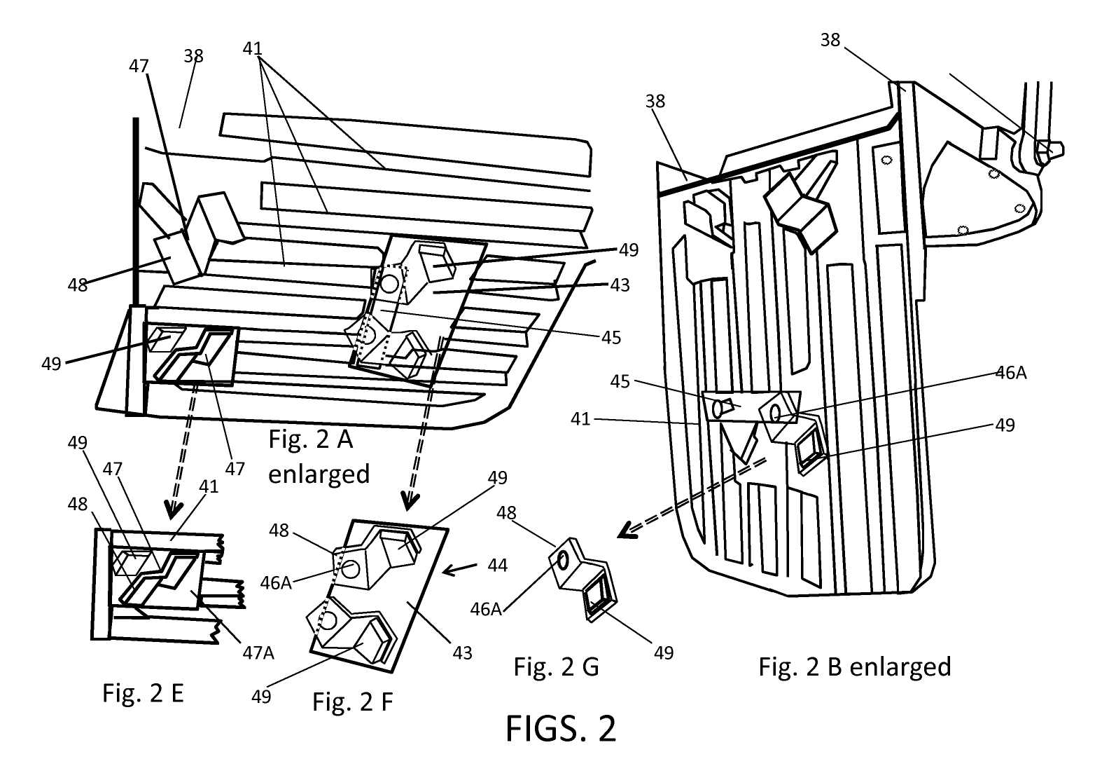

FIGS. 2 A through 2 G are sketches of the general passenger backrest, arm rests and luggage rack device (for a motorcycle) with components and features noted.

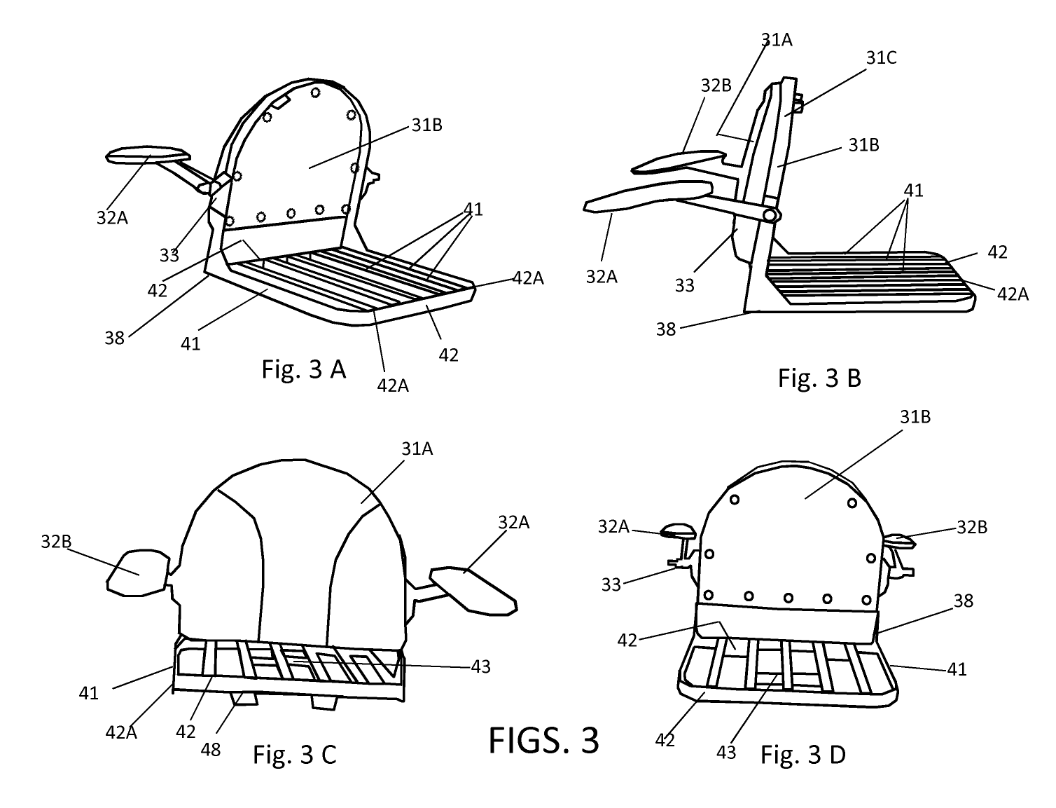

FIGS. 3 A through 3 D are additional sketches of a prototype sample of the passenger backrest, arm rests and luggage rack device (for a motorcycle) with the components and features shown from various views.

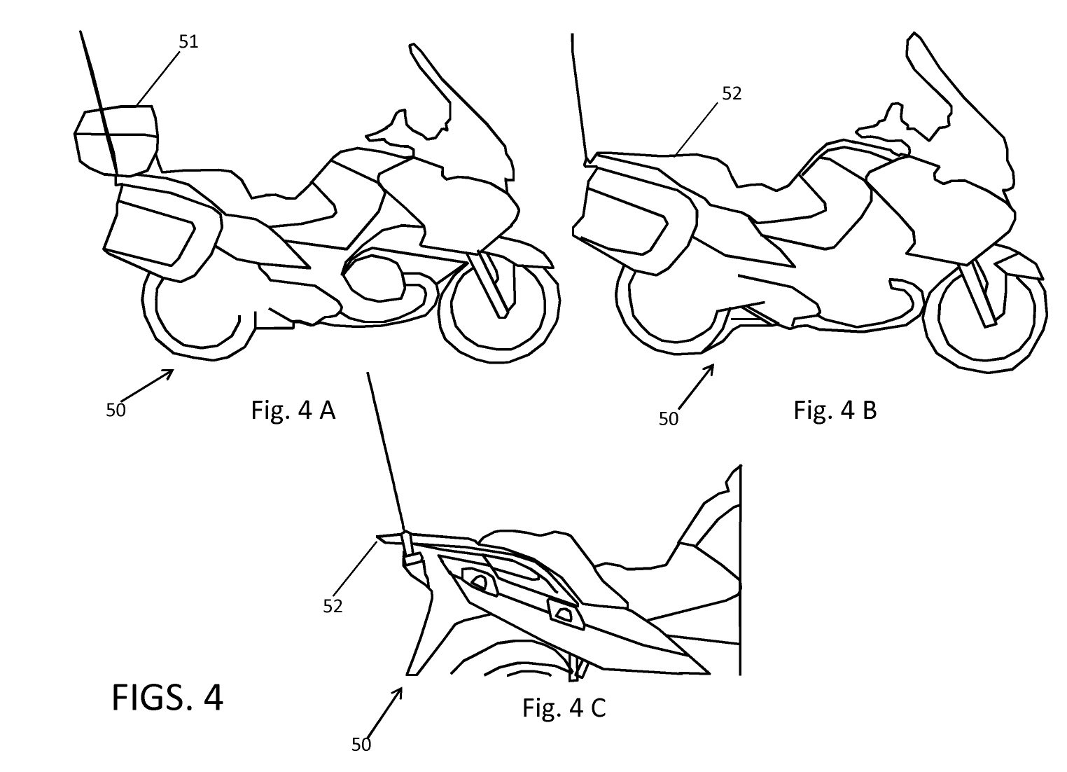

FIGS. 4 A through 4 C are sketches of a preparing the motorcycle for installing the passenger backrest, arm rests and luggage rack device (for a motorcycle).

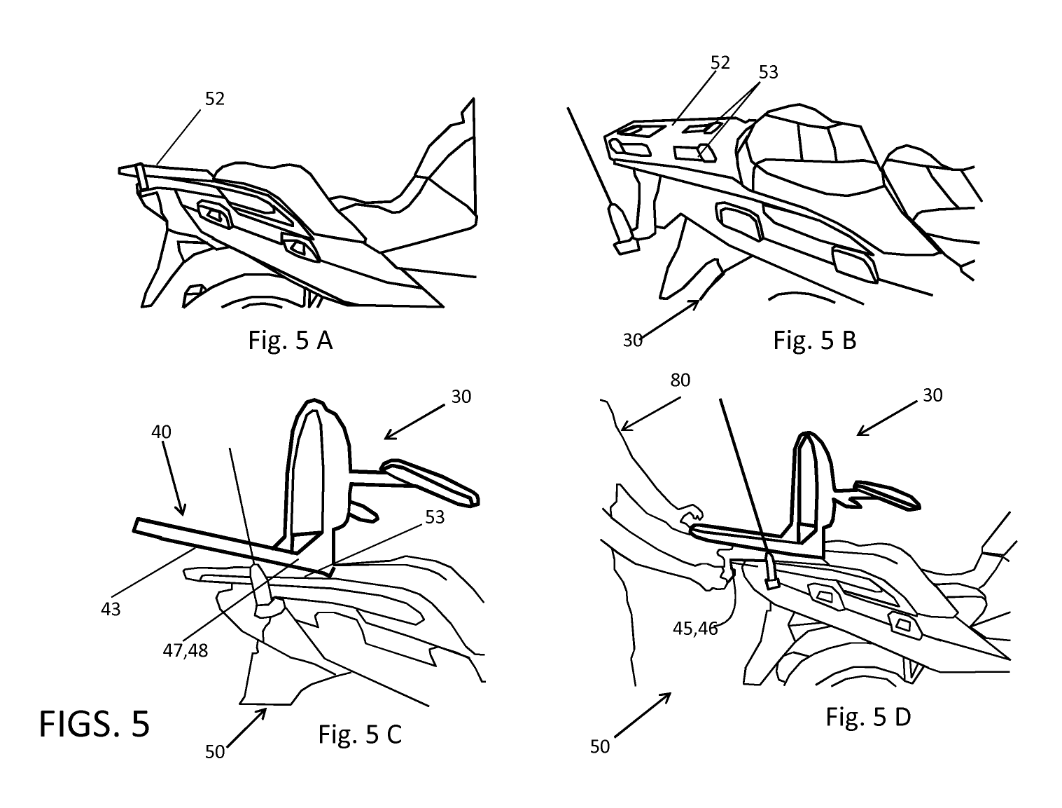

FIGS. 5 A through 5 D are sketches of a prototype combination device as it is installed onto the motorcycle.

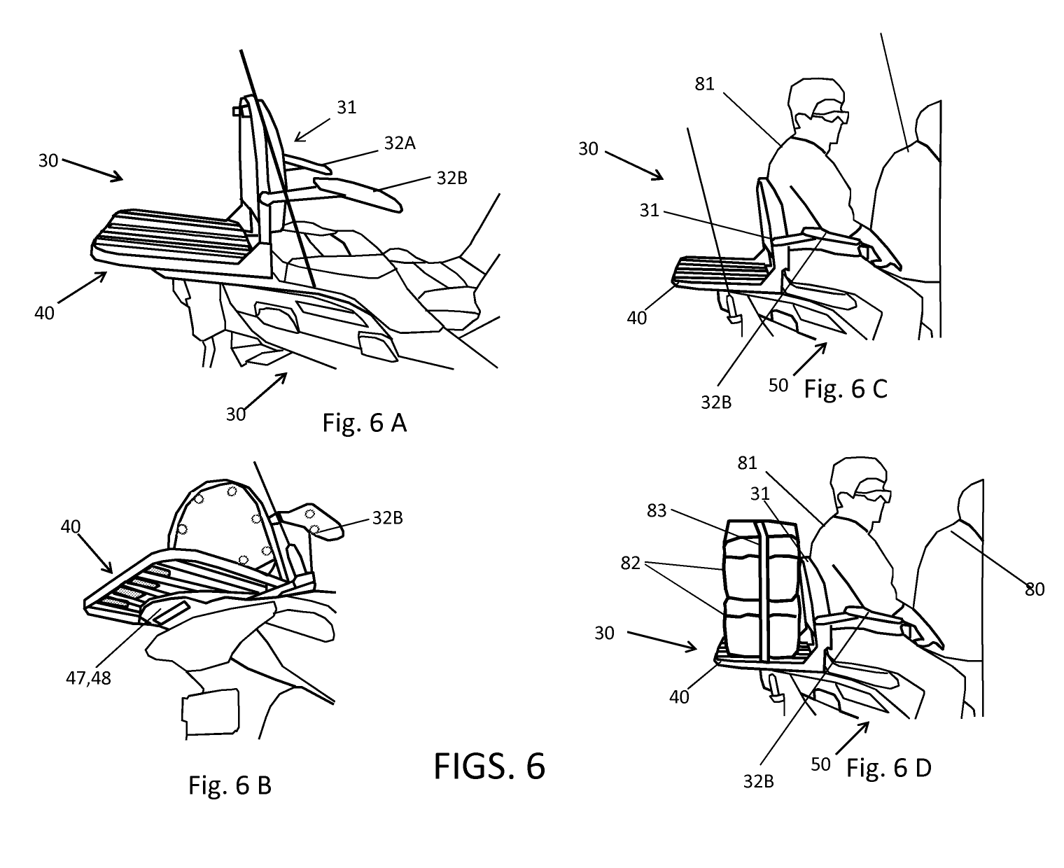

FIG. 6 A through 6 D are sketches of the passenger backrest, arm rests and luggage rack device (for a motorcycle) as it is installed and used.

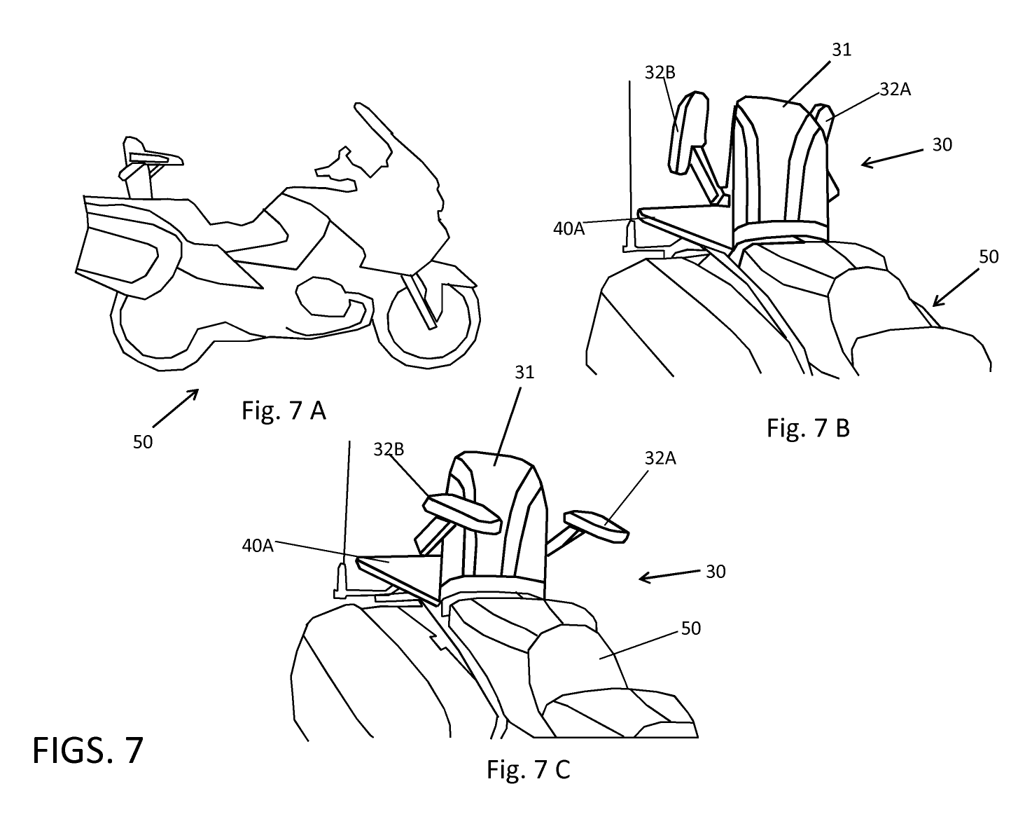

FIG. 7 A through 7 C are sketches of the combination device from various views on the motorcycle.

### DESCRIPTION OF THE DRAWINGS

### Reference Numerals

The following list refers to the drawings.

| Ref # | Description |
|---|---|
| 30 | General passenger backrest, arm rests and luggage rack |
| | combination device(for a motorcycle) |
| 31 | Passenger Back Rest/Support |
| 31A | Front of back/support |
| 31B | Rear of back rest/support |
| 31C | Side surface of back rest/support |
| 32 | Arm rest members (Left 32A and Right 32B) |
| 33 | Pivotal means for connecting arm rest member(s) to side |
| | surface of back support |
| 38 | Means for securing backrest 31 to flat planar luggage rack |
| | structure 40 |
| 40 | Flat planar luggage rack structure with structural strap |
| | members 41, 42 |
| 40A | Luggage rack - alternative embodiment - structural plate |
| 41 | Longitudinal structural member |
| 42 | Lateral structural member |
| 42A | Means for connecting longitude structure to lateral structure |
| 43 | Upper hold down plate(UHDP) |
| 44 | Means for connecting and securing UHDP 45 and securing rear |
| | insert plate 47A to longitudinal structure 41 such as welding |
| | or the like) |
| 45 | Lower hold down bar LHDB |
| 46 | Means to removably fasten UHDP to LHDB (bolt and nut, rivets, |
| | rods and cotter pins, or the like) |
| 46A | Threaded aperture or threaded fastening - if needed |
| 47 | Rear Insert Structure |
| 47A | Rear insert plate |
| 48 | Off set lead for rear insert structure |
| 49 | Elastic bumper pad to cushion combination of the device to the |
| | motorcycle structure (as many as 4 places) rubber, neoprene, |
| | synthetic composite material or the like |
| 50 | Motorcycle |
| 51 | Tour box |
| 52 | Support for tour box |
| 53 | Structural aperture (slot openings between ribs) in rear cargo |
| | support |
| 80 | Motorcycle Drive - controlling the motorcycle -i.e. “Rider” |
| 81 | Motorcycle passenger |
| 82 | Luggage, case box or the like |
| 83 | Means for removably securing such as a Hold down cord, strap, |
| | bungee cord or the like to removably secure luggage 82 to the |
| | flat planar luggage rack structure 40 |

### Detailed Description of Preferred Embodiment

The present development is an easy attach rear passenger backrest, arm rests and luggage rack device (for a motorcycle) called a STRONGRAK.

What is taught here is a product that is related to a touring motorcycle modification kit that enables riders to add an assembly configurable to function as a luggage rack and as a support for a passenger seat and arm rest combination. The easy to attach device has a simple means to attach the STRONGRAK securely and quickly to the motorcycle. It also is configured to not harm or scratch any surfaces and may be removed to return the motorcycle back to its original condition.

The advantages for the Strongrak combination device 30 are listed above in the introduction. Succinctly the benefits are that the device is a unit that: is comfortable, is durable, affords additional luggage capabilities, is lightweight, is attractive, and offers a relative to ground level lower center of gravity for the luggage than a standard touring box or rack.

The preferred embodiment of the easy to attach rear passenger backrest, arm rests and luggage rack device 30 (for a motorcycle) called a STRONGRAK is comprised of a (a) a backrest assembly 31; (b) a pair of arm rest members 32 consisting of a left 32A and right structure 32B; (c) a means 33 for pivotally securing each of the arm rest 32 members to the backrest assembly 31; (d) an essentially flat or planar luggage rack 40 with a front and rear end and two sides and with an upper and lower surface; (e) a means 38 for connecting the backrest assembly 31 securely to the front end of the luggage rack 40; and (f) a means 46, 48 for removably securing the lower surface of the flat, planar luggage rack 40 to a slot 53 in a support 52 of the motorcycle 50 wherein the Strongrak 30 may be removably secured on the motorcycle support 52 for use by a motorcycle passenger 81. The device 30 may be of various coated or plated metals, composite materials and other durable materials as one skilled in the art of motorcycle accessories well appreciates.

There is shown in FIGS. 1-7 a complete description and operative embodiment of the Strongrak combination device. In the drawings and illustrations, one notes well that the FIGS. 1 A, 2, 3, 6 and 7 demonstrate the general configuration of this product. FIGS. 1 B through 1 D, 4, 5, and 6 demonstrate the general use of this product. The various example uses are in the operation and use section, below.

The accompanying drawings, which are incorporated in and constitute a part of this specification, illustrate an embodiment of the Strongrak combination device 30 that is preferred. The drawings together with the summary description given above and a detailed description given below serve to explain the principles of the Strongrak combination device 30. It is understood, however, that the Strongrak combination device 30 is not limited to only the precise arrangements and instrumentalities shown. Other examples of motorcycle accessory devices and uses are still understood by one skilled in the art of motorcycle parts and accessories to be within the scope and spirit shown here.

FIG. 1 A is a sketch of the general passenger backrest 31, arm rest members 32 and flat, planar luggage rack 40 device 30 (for a motorcycle) called a STRONGRAK. The components and features are shown in additional descriptions below. FIGS. 1 B through 1 D are sketches of the use and described in the operations section below.

FIGS. 2 A through 2 G are sketches of the general passenger backrest 31, arm rest members 32 and luggage rack 40 of the device 30 (for a motorcycle 50) with components and features noted. FIG. 2 A shows backrest 31 with a front surface 31A and rear surface 31B. The right arm rest member 32B is pivoted and secure in the down position. Parts of the flat, planar luggage rack 40 are also shown: the longitudinal structural member 41 and the lateral ends 42; a means 44 for connecting (such as welding or fasteners) the longitudinal and lateral members 41, 42; the means 38 (such as welding or fasteners) for securing the backrest 31 to the luggage rack 40; the rear insert structure 47 connected by securing by a means 44 (welding or fasteners or the like) it 47 to the rear plate 47A wherein the rear plate(s) is/are secured (welding or fasteners or the like) to the structural members 41,42; an upper hold down plate 43 is secured by a means 44 (welding or fasteners or the like) to the middle three longitudinal structural members 41; and the lower/outer hold down strap/plate/bar 45 is removably secured by a means 46 (such as a threaded bolt and nut, a rod and cotter pins, or other common fasteners) to the upper hold down plate 43. FIG. 2 B shows the similar components from a different angle—essentially an under view—as well as the means 33 to pivotally connect the arm rest members 32 to the backrest 31. FIG. 2 C shows the components from an essentially top-isometric view both left arm rest member 32A and right arm rest member 32B at the pivot means 33. The side surface 31C of the backrest 31 is also demonstrated. FIG. 2 D shows the device 30 from an essentially top view from the rear. The aforementioned components are again shown.

FIGS. 2 A Enlarged and 2 B Enlarged show the components in a larger view plus some additional components and features in place. These additional features and components are further demonstrated by FIGS. 2 E, 2 F, and 2 G. Here are portrayed and exemplified: The rear insert structure 47 with the plate 47A laid contiguous to and secured across the longitudinal structural members 41; likewise the offset lead 48 may be seen which permits the device 30 to be attached to the motorcycle slots 53 onto the motorcycle support 52 (shown in other views). Additionally, these views show the elastic bumper pad 49 to cushion combination of the device 30 to the motorcycle 50 structural slots 53 (as many as 4 places). This bumper may be made of rubber, neoprene, synthetic composite material or the like. One may view the plates 47A, 43, the member offsets 48, the bumpers 49, and the apertures 46A (threaded or not depending on the fastening means) all positioned on the underside of the flat, planar luggage rack 40. One may also note that the luggage rack that is preferred is a lattice of longitudinal and lateral members 41, 42. However, a solid plate such as seen in FIGS. 7 B and 7 C may be an alternative rack 40A.

FIGS. 3 A through 3 D are additional sketches of a prototype sample of the device 30 of the passenger backrest 31, arm rests member(s) 32 and luggage rack 40 device (for a motorcycle 50) with the components and features shown from various views. FIG. 3 A shows a view from essentially the rear isometric view from behind the motorcycle when installed, FIG. 3 B shows essentially a side view from the left side of the motorcycle when the device 30 is installed, FIG. 3 C shows essentially a front/rider's 80 view of the motorcycle when the device 30 is installed, and FIG. 3 D shows essentially a full rear view when the device 30 is installed. All of the components indicated are described above in the other paragraphs.

The device structural members may be made of various coated or plated metals, composite materials and other durable materials as one skilled in the art of motorcycle accessories well appreciates. These include, for example and not as a limitation, aluminum, anodized aluminum, steel, chrome plated steel, stainless steel, powder coated steel, various composite materials and high strength reinforced materials. The backrests 31 and arm rest members are made of durable plastic or vinyl, leather, simulated leather and the like.

FIGS. 4 A through 4 C and FIGS. 5 A through 5 D are sketches of a prototype combination device as it is installed onto the motorcycle. These are described below.

FIG. 6 A through 6 D are sketches of the device 30 with the passenger backrest 31, arm rest members 32A, 32B and luggage rack 40 as it is installed on the motorcycle 50 and used by the rider 80 and passenger 81. Shown well in FIG. 6 D is the luggage 82 such as suitcase luggage (soft or hard shell), case box or the like all being retained by a means for removably securing 83 such as a Hold down cord, strap, bungee cord or the like.

FIG. 7 A through 7 C are sketches of the combination device 30 from various views on the motorcycle 50. The various components and features shown have been described above.

The details mentioned here are exemplary and not limiting. Other specific components and manners specific to describing a Strongrak combination device 30 may be added as a person having ordinary skill in the field of motorcycles and motorcycle accessories well appreciates.

### Operation of the Preferred Embodiment

The easy to attach rear passenger backrest, arm rests and luggage rack device 30 (for a motorcycle) called a STRONGRAK has been described in the above embodiment. The manner of how the device operates is described below. One notes well that the description above and the operation described here must be taken together to fully illustrate the concept of the Strongrak combination device 30. The preferred embodiment of the easy to attach rear passenger backrest, arm rests and luggage rack device 30 (for a motorcycle) called a STRONGRAK is comprised of a (a) a backrest assembly 31; (b) a pair of arm rests 32 consisting of a left 32A and right structure 32B; (c) a means 33 for pivotally securing each of the armrest 32 structures to the backrest assembly 31; (d) an essentially flat or planar luggage rack 40 with a front and rear end and two sides and with an upper and lower surface; (e) a means 38 for connecting the backrest assembly 31 securely to the front end of the flat, planar luggage rack 40; and (f) a means 46, 48 for removably securing the lower surface of the luggage rack structure 40 to a slot 53 in a support 52 of the motorcycle 50 wherein the Strongrak 30 may be removably secured on the motorcycle support 52 for use by a motorcycle passenger 81.

The Strongrak combination device 30 operates by installing the device onto the rear tour box support 51 support 52 in the slots 53 (apertures between the ribs) These steps are similar to these:

| Step | Description |
|---|---|
| 1 | Remove the tour box 51 from the motorcycle 50. |
| 2 | Tip new device 30 to about 30 degrees and slide |
| | front forks 48 under slots 53. |
| 3 | Lower device 30 to horizontal, contiguous to bike |
| | support 52, at the time permitting the device 30 |
| | rear leads 48 to drop below support 52 plane and |
| | allow rubber mounts 49 to protect and support the |
| | device 30. |
| 4 | Place removable fastening means 46 (bolts or the |
| | like) through locking bar 45. |
| 5 | Secure/tighten fastening means 46 (bolts or the |
| | like). |
| 6 | Place cargo/luggage on rear flat upper plane of the |
| | luggage rack 40 of the device 30. |
| 7 | Secure cargo as needed with cords or straps as one |
| | skilled in the art well understands. |
| 8 | Rotate seat arms 32A, 32B for passenger 81 use as |
| | needed |
| 9 | Reverse steps to remove device 30. |

FIGS. 1 B through 1 D are sketches of the device 30 and the use of the general passenger backrest 31, arm rest members 32 and luggage rack 40. The specifics have been described in other views. FIG. 1 B shows the rear section of the motorcycle and support slots 53 where the device 30 is removably attached. FIG. 1 C shows the device 30 mounted. FIG. 1 D shows the device 30 mounted to the motorcycle 50 with the rider 80 and passenger 81 using the device.

FIGS. 4 A through 4 C are sketches of a preparing the motorcycle 50 for installing the device 30 with the passenger backrest 31, arm rest member(s) 32 and luggage rack 40. FIG. 4 A shows the motorcycle 50 with the tour box 51 attached. FIG. 4 B shows the motorcycle 50 with the tour box 51 removed and the tour box support 52 behind the rider's seat. FIG. 4 C shows the tour box support 52 ready for the device 30.

FIGS. 5 A through 5 D are additional sketches of a prototype combination device 30 as it is installed onto the motorcycle 50. FIG. 5 A again shows the tour box support 52 ready for the device 30. FIG. 5 B shows the tour box support 52 and the slots 53 (openings between the support ribs) and ready for removably mounting the device 30. FIG. 5 C shows tipping the new device 30 to about 30 degrees and sliding the front forks 48 under slots 53. FIG. 5 D shows lowering device 30 to horizontal, contiguous to bike support 52, at the time permitting the device 30 rear leads 48 to drop below support 52 plane and allowing rubber mounts 49 to protect and support the device 30; placing the removable fastening means 46 (bolts or the like) through locking bar 45; ant then starting to secure/tighten fastening means 46 (bolts or the like).

FIG. 6 A through 6 C are sketches of the device 30 with the passenger backrest 31, arm rest member(s) 32A, 32B and luggage rack 40 as it is installed on the motorcycle 50 and used by the rider 80 and passenger 81. These were described above.

With this description it is to be understood that the Strongrak combination device 30 is not to be limited to only the disclosed embodiment of product. The features of the easy to attach rear passenger backrest, arm rest members and luggage rack device 30 (for a motorcycle) called a STRONGRAK are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless they are defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other of the embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless they are otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. An easy to remove and attach passenger backrest, arm rests and luggage rack device for mounting to a motorcycle comprised of:
(a) a backrest assembly;
(b) a pair of arm rest members consisting of a left and right member;
(c) a means for pivotally and removably securing each of the arm rest member to the backrest assembly;
(d) an essentially flat planar luggage rack structure made of durable material, the luggage rack structure with a front and rear end member and two side members and the luggage rack with an upper and lower surface, the front rear and side members of the luggage rack structure rigidly secured by a means for securing the members as the one luggage rack structure;
(e) a means for connecting the backrest assembly securely to the front end of the luggage rack structure; and
(f) a means for removably securing the lower surface of the luggage rack to a slot in a support of the motorcycle
wherein the passenger backrest, arm rest members and luggage rack device may be removably secured on the motorcycle support for use by a motorcycle passenger and for use carrying luggage.

2. The passenger backrest, arm rests and luggage rack device according to claim 1 comprising a means for removably securing luggage to the flat planar luggage rack structure.

3. The flat planar luggage rack structure according to claim 1 comprising an elastic bumper pad made of durable materials
whereby the bumper pad cushions the passenger backrest, arm rests and luggage rack device from the motorcycle support.

4. The device according to claim 3 wherein the durable material of the elastic bumper pad is from the group consisting of plastic, urethane, rubber, neoprene, and a composite material.

5. The device according to claim 1 wherein the durable material of the flat planar luggage rack structure is from the group consisting of aluminum, anodized aluminum, steel, chrome plated steel, stainless steel, powder coated steel, composite materials and high strength reinforced composite materials.

6. The device according to claim 1 wherein the means for connecting the longitudinal and lateral members is welding.

7. The device according to claim 1 wherein the means for connecting the longitudinal and lateral members is a plurality of mechanical fasteners.

8. The device according to claim 1 wherein the means for connecting the back rest to the flat planar luggage rack structure is welding.

9. The device according to claim 1 wherein the means for connecting the back rest to the flat planar luggage rack structure is at least one mechanical fasteners.

10. The device according to claim 1 wherein the means for connecting the flat planar luggage rack structure to the motorcycle support is a lower/outer hold down strap removably secured by a means for securing to an upper hold down plate.

11. An easy to remove and attach passenger backrest, arm rests and luggage rack device for mounting to a motorcycle comprised of:
(a) a backrest assembly;
(b) a pair of arm rest members consisting of a left and right member;
(c) a means for pivotally and removably securing each of the arm rest member to the backrest assembly;
(d) an essentially flat planar luggage rack structure made of durable material, the luggage rack structure with a front and rear end member and two side members and the luggage rack with an upper and lower surface, the front rear and side members of the luggage rack structure rigidly secured by a means for securing the members as the one luggage rack structure;
(e) an elastic bumper pad made of durable materials inter-placed between the luggage rack structure and a support of the motorcycle;
(f) a means for connecting the backrest assembly securely to the front end of the luggage rack structure; and
(g) a means for removably securing the lower surface of the luggage rack to a slot in the support of the motorcycle
wherein the passenger backrest, arm rest members and luggage rack device may be removably secured on the motorcycle support for use by a motorcycle passenger and for use carrying luggage.
